(19) United States
(12) Patent Application Publication
(10) Pub. No.: US 2024/0318022 A1
(43) Pub. Date: Sep. 26, 2024

(54) Ink Jet Ink Composition And Recording Method

(71) Applicant: SEIKO EPSON CORPORATION, Tokyo (JP)

(72) Inventors: Akinobu SUMIYOSHI, Shiojiri (JP); Kenta UCHIDA, Matsumoto (JP); Yusuke MIZUTAKI, Shiojiri (JP)

(21) Appl. No.: 18/613,316

(22) Filed: Mar. 22, 2024

(30) Foreign Application Priority Data
Mar. 23, 2023 (JP) 2023-046391

(51) Int. Cl. C09D 11/38; B41J 2/01; C09D 11/322

(52) U.S. Cl. CPC C09D 11/38; C09D 11/322; B41J 2/01

(57) ABSTRACT

Provided is an aqueous ink jet ink composition including a self-dispersing pigment, a water-soluble resin, and a betaine, in which the self-dispersing resin is a self-dispersing resin obtained by introducing a phosphorus-containing group to the pigment, the water-soluble resin has an acid value of 250 mgKOH/g or greater and 600 mgKOH/g or less, a content of the self-dispersing pigment is 3.5% by mass or greater and 8.5% by mass or less with respect to a total mass of the ink composition, a mass ratio (self-dispersing pigment/water-soluble resin) of the self-dispersing pigment to the water-soluble resin is 2.8 or greater and less than 30, and a content of the betaine is 2.5% by mass or greater and 9.5% by mass or less with respect to the total mass of the ink composition.

The present application is based on, and claims priority from JP Application Serial Number 2023-046391, filed Mar. 23, 2023, the disclosure of which is hereby incorporated by reference herein in its entirety.

### BACKGROUND

### 1. Technical Field

The present disclosure relates to an ink jet ink composition and a recording method.

### 2. Related Art

Ink jet recording has been performed in a wide range of fields. The ink jet recording is actively employed for household use and business use. Further, remote work and small offices/home offices have been increasing, and thus printing at home has also been increased.

For example, JP-A-2015-061896 discloses an ink composition containing a pigment, a resin, and an organic solvent, in which the ink composition is poured into an ink container including an ink chamber configured to replenish the ink composition and an ink filling hole configured to be opened and closed, in which the ink chamber is configured to communicate with outside air.

The color developability of an ink jet printed material on plain paper is inferior when compared to a printing method such as an electrophotographic method. One reason for this is that since an ink jet ink composition is a liquid, a coloring material permeates into a recording medium together with the ink and thus does not remain on the surface of the recording medium. Further, in a case where a dispersion resin (resin particles) is used to improve scratch resistance of an image on the recording medium, resin particles are dried, formed into a film, and thus solidified when the ink jet ink composition is dried, and as a result, clogging recovering properties of a recording device may be degraded.

### SUMMARY

According to an aspect of the present disclosure, there is provided an aqueous ink jet ink composition including: a self-dispersing pigment; a water-soluble resin; and a betaine, in which the self-dispersing resin is a self-dispersing resin obtained by introducing a phosphorus-containing group to the pigment, the water-soluble resin has an acid value of 250 mgKOH/g or greater and 600 mgKOH/g or less, a content of the self-dispersing pigment is 3.5% by mass or greater and 8.5% by mass or less with respect to a total mass of the ink composition, a mass ratio (self-dispersing pigment/water-soluble resin) of the self-dispersing pigment to the water-soluble resin is 2.8 or greater and less than 30, and a content of the betaine is 2.5% by mass or greater and 9.5% by mass or less with respect to the total mass of the ink composition.

According to another aspect of the present disclosure, there is provided a recording method performed by using an ink jet recording device that includes an ink jet head, the method including: jetting an ink jet ink composition from the ink jet head to make the ink jet ink composition adhere to a recording medium, in which the ink jet ink composition is the ink jet ink composition described above.

### BRIEF DESCRIPTION OF THE DRAWINGS

FIG. 1 is a schematic view showing an example of an ink jet recording device.

FIG. 2 is a block diagram showing an example of the ink jet recording device.

FIG. 3 is a table (Table 1) listing the formulation and the like of compositions of examples.

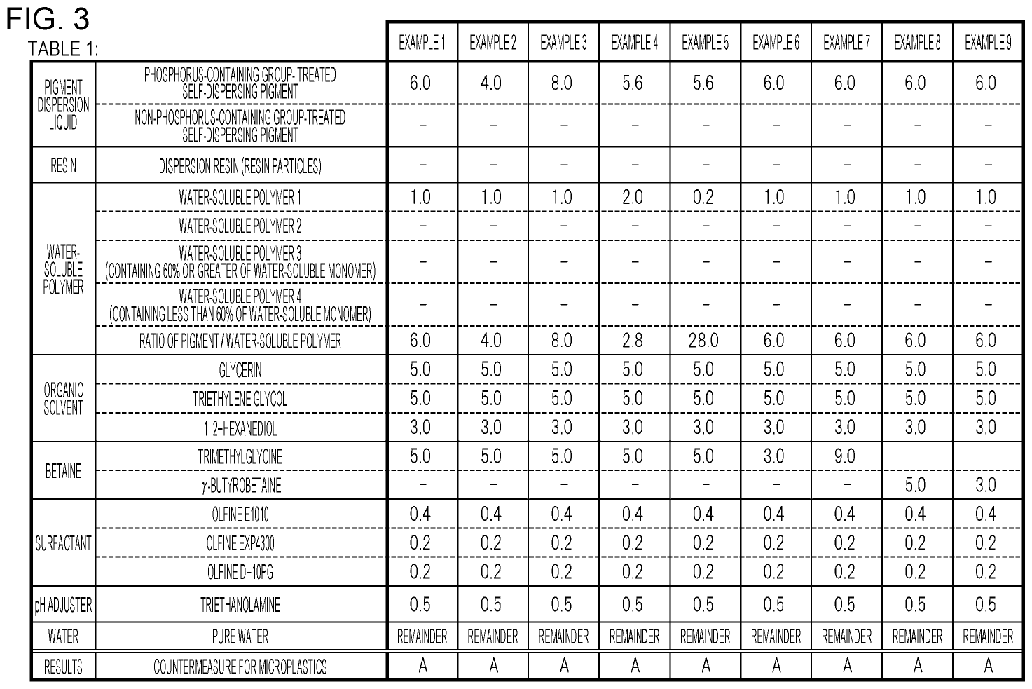

FIG. 4 is a table (Table 2) listing the formulation and the like of compositions of examples and comparative examples.

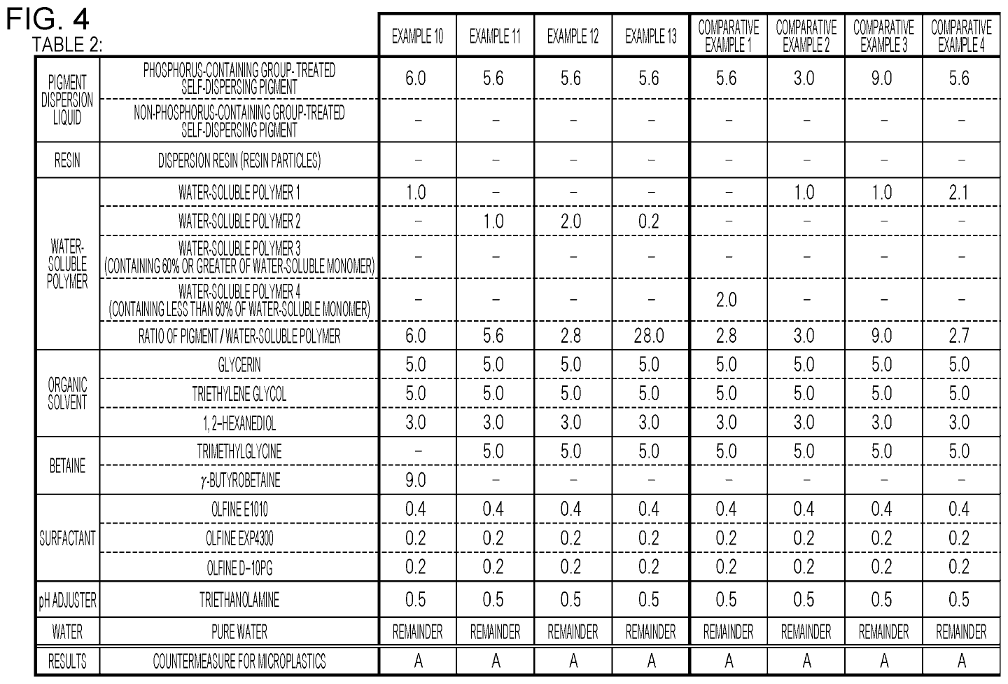

FIG. 5 is a table (Table 3) listing the formulation and the like of compositions of comparative examples and reference examples.

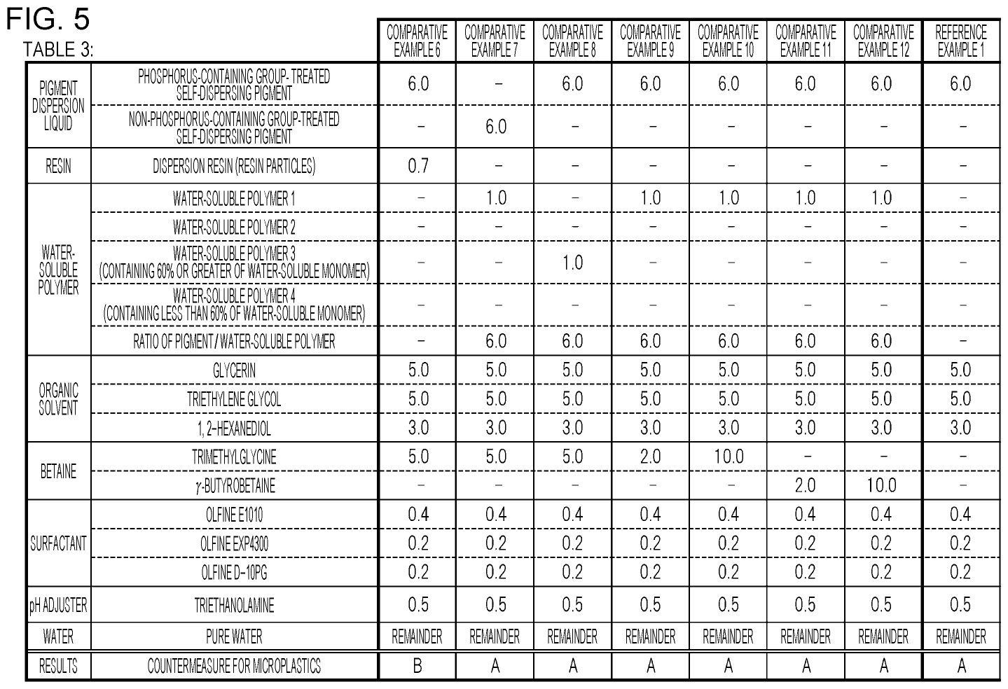

FIG. 6 is a table (Table 4) listing the evaluation results of compositions of examples.

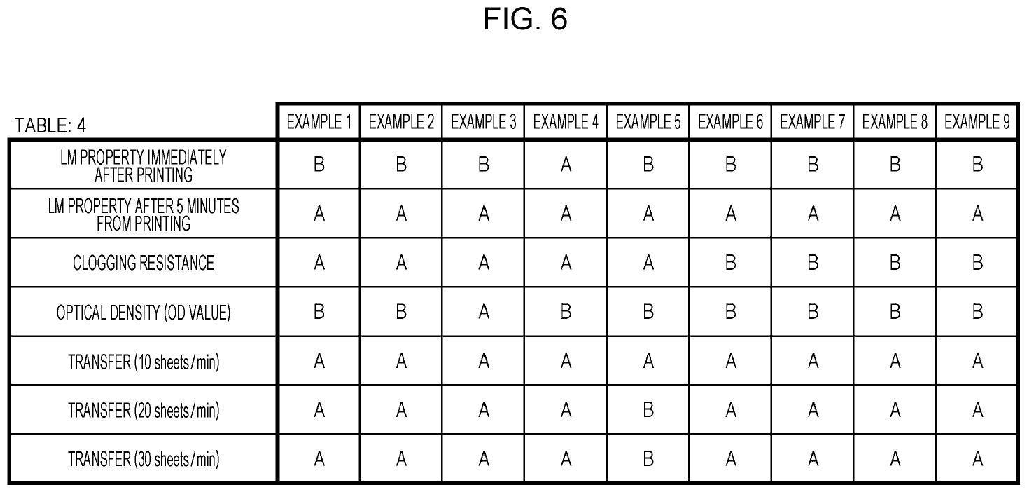

FIG. 7 is a table (Table 5) listing the evaluation results of compositions of examples and comparative examples.

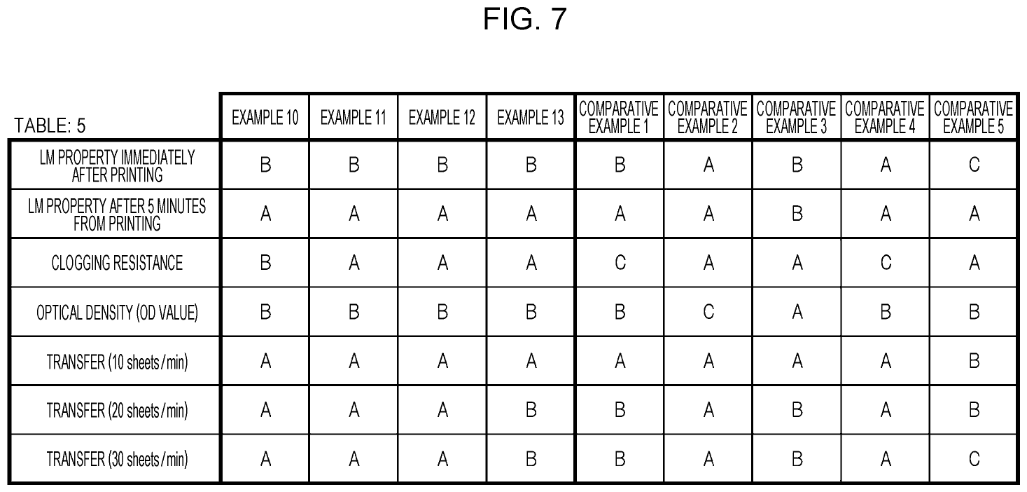

FIG. 8 is a table (Table 6) listing the evaluation results of compositions of comparative examples and reference examples.

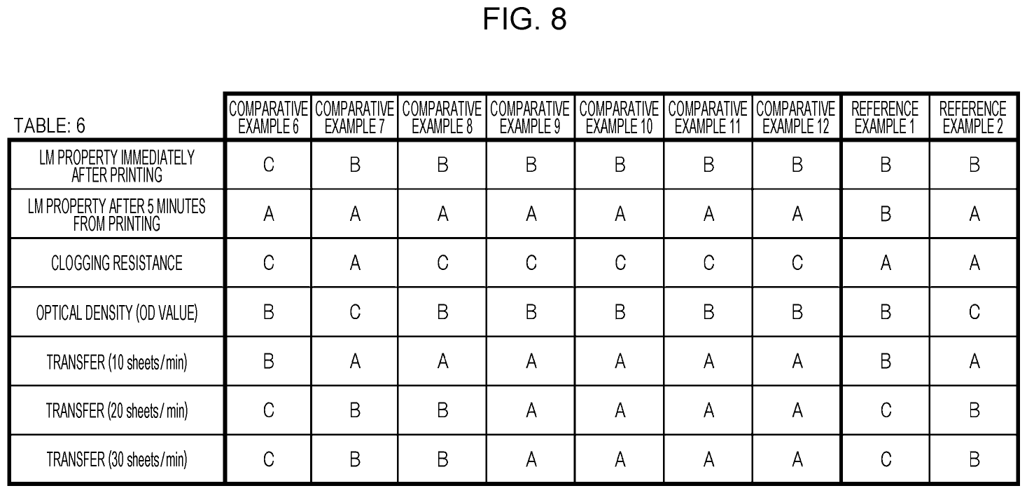

### DESCRIPTION OF EMBODIMENTS

Hereinafter, embodiments of the present disclosure will be described. The embodiments described below are examples of the present disclosure. The present disclosure is not limited to the following embodiments and also includes various modifications implemented within a range not departing from the scope of the present disclosure. Further, not all configurations described below are essential configurations of the present disclosure.

### 1. Ink Jet Ink Composition

An ink jet ink composition of the present embodiment is an aqueous composition containing a self-dispersing pigment, a water-soluble resin, and a betaine.

### 1.1. Self-Dispersing Pigment

The ink jet ink composition according to the present embodiment contains a self-dispersing pigment obtained by introducing a phosphorus-containing group to the pigment. The self-dispersing pigment is a pigment that can be dispersed and/or dissolved in an aqueous medium without a dispersant such as a resin or a surfactant. Here, the expression of “dispersed and/or dissolved in an aqueous medium without a dispersant” denotes a state where the pigment is stably present in an aqueous medium due to a hydrophilic group on the surface thereof even when a dispersant for dispersing the pigment is not used.

Since the ink jet ink composition containing a self-dispersing pigment is not required to contain a dispersant for dispersing a pigment, formation of air bubbles and degradation of defoaming properties caused by a dispersant are unlikely to occur, and thus the jetting stability is likely to be improved. Further, generation of foreign matter at a gas-liquid interface caused by a dispersant when the ink jet ink composition is dried is suppressed, and thus the jetting reliability is also excellent. Further, since a significant increase in viscosity caused by a dispersant is suppressed, the ink jet ink composition can be allowed to contain a larger amount of pigment, and as a result, the print density can be further increased in some cases.

Further, when a recording medium contains calcium, an image with excellent color developability is likely to be formed due to the reaction between the self-dispersing pigment and the calcium. The self-dispersing pigment according to the present embodiment is a self-dispersing pigment having a surface to which a phosphorus-containing group is bonded, and thus such color developability is likely to be obtained. The tendency is significant particularly in a case of a self-dispersing pigment having a surface to which a phosphonic acid group is bonded.

The self-dispersing pigment tends to have slightly inferior fixing properties of an image compared to a pigment formed such that an anionic resin is physically adsorbed on the surfaces of pigment particles or a resin dispersing pigment dispersed in a state where an anionic resin contains a pigment, but the ink jet ink composition according to the present embodiment can exhibit excellent fixing properties of an image by using a water-soluble resin described below.

Examples of the self-dispersing pigment to which a phosphorus-containing group is introduced include a pigment obtained by bonding a phosphorus-containing group to the surface of the pigment directly or via other atomic groups. Examples of the phosphorus-containing group

contained in the surface of the self-dispersing pigment include a phosphoric acid group, a phosphonic acid group, —PO₃HM, and —PO₃M₂. Among these, a phosphoric acid group is more preferable. In the formulae, M represents a hydrogen atom, an alkali metal, ammonium, or an organic amine, and R represents an alkyl group having 1 or more and 12 or less carbon atoms or a naphthyl group which may have a substituent.

Further, examples of the other atomic groups include a linear or branched alkyl group having 1 or more and 12 or less carbon atoms, a phenylene group, a naphthylene group, an amide group, a sulfonyl group, an amino group, a carbonyl group, an ester group, an ether group, and a group obtained by combining these groups.

A pigment in which a phosphorus-containing group is bonded to the surfaces of the pigment particles by a known method and a pigment in which a functional group containing a phosphorus-containing group is bonded to the surfaces of the pigment particles by performing diazo coupling may be employed as the above-described self-dispersing pigments, and both pigments can be suitably used. The self-dispersing pigment obtained by bonding an anionic resin to the surfaces of the pigment particles may be a pigment in which a resin having a unit containing at least a phosphorus-containing group as a hydrophilic unit is bonded to the surfaces of the pigment particles directly or via other atomic groups.

The pigment of a self-dispersion type is not particularly limited, and examples of the kind of pigment include an inorganic pigment such as carbon black, calcium carbonate, or titanium oxide, and an organic pigment such as an azo pigment, an isoindolinone pigment, a diketopyrrolopyrrole pigment, a phthalocyanine pigment, a quinacridone pigment, or an anthraquinone pigment.

Examples of a black pigment include No. 2300, No. 900, MCF88, No. 33, No. 40, No. 45, No. 52, MA7, MA8, MA100, and No. 2200B (all manufactured by Mitsubishi Chemical Corporation), Raven 5750, Raven 5250, Raven 5000, Raven 3500, Raven 1255, and Raven 700 (all manufactured by Columbia Carbon Co., Ltd.), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all manufactured by Cabot Corporation), and Color Black FW1, Color Black FW2, Color Black FW2V, Color Black FW18, Color Black FW200, Color black S150, Color Black S160, Color Black S170, Printex 35, Printex U, Printex V, Printex 140U, Special Black 6, Special Black 5, Special Black 4A, and Special Black 4 (all manufactured by Degussa-Huls AG).

Examples of a white pigment include C.I. Pigment White 1 (basic lead carbonate), 4 (zinc oxide), 5 (mixture of zinc sulfide and barium sulfate), 6 (titanium oxide), 6:1 (titanium oxide containing other metal oxides), 7 (zinc sulfide), 18 (calcium carbonate), 19 (clay), 20 (titanium mica), 21 (barium sulfate), 22 (natural barium sulfate), 23 (gloss white), 24 (alumina white), 25 (gypsum), 26 (magnesium oxide/silicon oxide), 27 (silica), and 28 (anhydrous calcium silicate).

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of a cyan pigment include C.I. Pigment Blue 1, 2, 3, 15, 15:1, 15:2, 15:3, 15:34, 15:4, 16, 18, 22, 25, 60, 65, and 66, and C.I. Vat Blue 4 and 60.

Examples of pigments of colors other than black, white, yellow, magenta, and cyan include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

Further, examples of color pigments include phthalocyanine-based pigments, azo-based pigments, anthraquinone-based pigments, azomethine-based pigments, and fused ring-based pigments in addition to Pigment yellow Series, Pigment Red Series, Pigment Violet Series, and Pigment Blue Series listed in the color index. Further, other examples thereof include organic pigments such as Yellow No. 4, No. 5, No. 205, and No. 401, Orange No. 228 and No. 405, and Blue No. 1 and No. 404, and inorganic pigments such as titanium oxide, zinc oxide, zirconium oxide, iron oxide, ultramarine, Prussian blue, and chromium oxide.

The above-described pigments can be defined as the pigments obtained by bonding a phosphorus-containing group to the surfaces of the particles directly or via other atomic groups.

In addition, examples of pigments other than carbon black used as the self-dispersing pigment include a pigment obtained by bonding a phosphorus-containing group to the surface of the pigment via a phenyl group. Various known surface treatment methods can be applied as a surface treatment method of bonding the above-described functional group as a phosphorus-containing group or a salt thereof to the surface of the pigment via a phenyl group.

The content of the self-dispersing pigment (solid content) is 3.5% by mass or greater and 8.5% by mass or less with respect to the total mass of the ink jet ink composition. Further, the content of the self-dispersing pigment (solid content) is preferably 4% by mass or greater and more preferably 4.5% by mass or greater with respect to the total mass of the ink jet ink composition. Further, the content of the self-dispersing pigment (solid content) is preferably 8% by mass or less, more preferably 7.5% by mass or less, and particularly preferably 7% by mass or less with respect to the total mass of the ink jet ink composition. When the content of the self-dispersing pigment is in the above-described ranges, the color developability and clogging recovering properties may be improved.

In the ink jet ink composition according to the present embodiment, the amount of the water-soluble resin and the amount of the self-dispersing pigment to be blended are set such that the mass ratio (self-dispersing pigment/water-soluble resin) of the self-dispersing pigment to the water-soluble resin is set to 2.8 or greater and less than 30. Further, such a mass ratio is preferably 3.0 or greater and less than 28 and more preferably 3.2 or greater and less than 25.

The rub resistance of an image is degraded when the amount of the water-soluble resin is small with respect to the amount of the self-dispersing pigment, and the clogging resistance may be degraded when the amount of the water-soluble resin is large with respect to the amount of the self-dispersing pigment.

Further, the self-dispersing pigment containing a phosphorus-containing group may contain an anionic group other than the phosphorus-containing group. In addition, the ink jet ink composition according to the present embodiment may contain a self-dispersing pigment containing no phosphorus-containing group.

### 1.2. Water-Soluble Resin

The ink jet ink composition according to the present embodiment contains a water-soluble resin having an acid value of 250 mgKOH/g or greater and 600 mgKOH/g or less. Further, the content of the water-soluble resin is set such that the mass ratio (self-dispersing pigment/water-soluble resin) of the self-dispersing pigment to the water-soluble resin is 2.8 or greater and less than 30.

The water-soluble resin mainly contributes to the fixing properties of an image. The water-soluble resin is different from resin particles and thus unlikely to be formed into foreign matter at the gas-liquid interface. However, when the water-soluble resin is dried at the gas-liquid interface, clogging resistance may be degraded due to the components that have been dried and solidified. Since the water-soluble resin is highly hydrophilic, the water-soluble resin is formed into foreign matter and unlikely to be redissolved in some cases when water is dried and the environment is hydrophobic. It is assumed that particularly the water-soluble resin and the self-dispersing pigment subjected to a hydrophilic treatment are formed into composite foreign matter and unlikely to be redissolved when water is dried and the environment is hydrophobic.

When the ink jet ink composition according to the present embodiment contains a betaine described below, a state in which the water-soluble resin is incorporated in (absorbed by) the betaine is considered to be formed, and as a result, it is assumed that formation of foreign matter from the water-soluble resin is suppressed and resolubility can be obtained even in a case where the water-soluble resin is formed into foreign matter. In this manner, the clogging resistance is considered to be enhanced.

Further, foreign matter mixed with other components such as the self-dispersing pigment is formed from the water-soluble resin in the ink jet in composition in some cases, but when the ink jet ink composition according to the present embodiment contains a betaine described below, a state in which the water-soluble resin is incorporated in (absorbed by) the betaine is considered to be formed, and as a result, it is assumed that formation of foreign matter from the water-soluble resin is suppressed and resolubility can be obtained even in a case where the water-soluble resin is formed into foreign matter. In this manner, the clogging resistance is considered to be enhanced.

Further, the water-soluble resin can also increase the fastness of an image. The mechanism of the water-soluble resin in increasing the fastness of an image is different from the mechanism of dispersion particles in improving the fastness of an image. The water-soluble resin is considered to have an action of fixing an image to a recording medium through a reaction with calcium (Ca) contained in a recoding medium. Meanwhile, the main mechanism of the resin particles is fixation of the resin using moisture evaporation, and the fixation of the resin takes a relatively long time. Therefore, a significant difference in the fastness is not observed after a certain amount of time has passed from the printing, but the water-soluble resin can exhibit excellent fastness earlier in a case of comparison immediately after the printing. Since the water-soluble resin quickly fixes ink components onto a recording medium through the reaction with Ca of the recording medium, the color developability is also more excellent.

In the present specification, the water-soluble resin is different from a resin for dispersing a pigment (pigment dispersion resin) used for dispersing a pigment and denotes a resin dissolved in an ink without adhering to a pigment by adsorption or the like. Further, in the present specification, the term “water-soluble” denotes a property that 3% by mass or greater of the resin can be dissolved in ion exchange water at 20° C. The amount of resin to be dissolved is preferably 5% by mass or greater, more preferably 10% by mass, and still more preferably 25% by mass or greater.

The expression of “can be dissolved” denotes that undissolved residues, turbidity, and layer separation are not observed after water and the resin is mixed and stirred. Further, the water-soluble resin is a resin dissolved in water without indicating a resin dispersion (resin particles) in which the resin is dispersed in water.

The water-soluble resin can be classified into an anionic resin, a nonionic resin, a cationic resin, and the like in terms of the characteristics. In the ink jet ink composition according to the present embodiment, it is preferable to use an anionic resin. It is preferable that the water-soluble resin contain an acidic group in the structure and have an acid value. The acidic group may be in the form of a salt. Examples of the acidic group include a carboxy group, a sulfonyl group, and a phosphoric acid group. Among these, a carboxy group is more preferable.

The acid value of the water-soluble resin used in the present embodiment is 250 [KOHmg/g] or greater and 600 [KOHmg/g] or less, preferably 300 [KOHmg/g] or greater and 500 [KOHmg/g] or less, more preferably 350 [KOHmg/g] or greater and 450 [KOHmg/g] or less, and still more preferably 400 [KOHmg/g] or greater and 450 [KOHmg/g] or less.

The acid value is measured by titration. For example, the acid value can be measured by a method (potentiometric titration method) in conformity with JIS K 0070:1992.

When the acid value of the water-soluble resin is in the above-described ranges, since the balance between the hydrophobic group and the hydrophilic group is satisfactory, an image with satisfactory water resistance while the solubility of the water-soluble resin in water is excellent can be obtained.

Meanwhile, when the acid value of the water-soluble resin is less than the above-described ranges, foreign matter is likely to be formed due to a decrease in the solubility of the water-soluble resin in water. Further, when the acid value of the water-soluble resin is greater than the above-described ranges, the water resistance of an image may be degraded due to an extreme increase in the solubility of the water-soluble resin in water. Further, the term “acid value” denotes the amount of KOH (mg) required to neutralize 1 g of the water-soluble resin.

Preferred examples of the water-soluble resin include an acrylic resin, a maleic acid-based resin, a urethane-based resin, and a polyester-based resin.

The acrylic resin is a resin polymerized using at least an acrylic monomer.

The maleic acid-based resin is a resin polymerized using at least maleic acid or a maleic acid derivative. More specific examples thereof include an acrylic resin, a styrene-acrylic resin, a styrene-maleic acid-based resin, an acrylonitrile-acrylic resin, a vinyl acetate-acrylic resin, a polyurethane-based resin, and a polyester-based resin. Further, it is preferable that the water-soluble resin be selected from an acrylic resin or a maleic acid-based resin.

Further, a maleic acid-based resin polymerized using at least maleic acid or a maleic acid derivative, such as a styrene-maleic acid-based resin, is more preferable. That is, the maleic acid-based resin is a polymer compound having a structure derived from maleic acids.

Further, a resin polymerized using at least an acrylic monomer and maleic acid or a maleic acid derivative is defined as the maleic acid-based resin.

Examples of the maleic acids include a compound having a structure in which one carboxyl group is bonded to each of adjacent carbon atoms bonded to each other via a carbon-carbon double bond of ethylene and a compound that is a derivative thereof.

Specific examples of the maleic acids include maleic acid, maleic anhydride, fumaric acid, citraconic acid, citraconic anhydride, and mesaconic acid. The maleic acids may be compounds obtained by cyclodehydrating or esterifying the carboxyl groups respectively bonded to the adjacent carbon atoms. The carboxyl groups include a carboxyl group that forms a salt.

Examples of the derivatives include a derivative in which a carboxyl group is derived as described above and a derivative in which an ethylene skeleton further has a substituent.

Among the maleic acids, a derivative in which maleic acid is derived and a derivative in which a carboxyl group of the maleic acid is derived are preferably used.

A carboxyl group derived from maleic acids may be cyclodehydrated or esterified as the maleic acid-based resin. The carboxyl group also includes a salt formed by a carboxyl group.

The polymer compound having a structure derived from maleic acids can be a polymer compound obtained by performing polymerization or copolymerization using at least maleic acids.

The maleic acid-based resin may be a polymer of maleic acids or a copolymer of maleic acids and other monomers. Examples of other monomers include vinyl monomers such as styrene, vinylnaphthalene, and vinyl acetate, and acrylic monomers such as (meth)acrylic acid and esters of (meth)acrylic acid.

The maleic acid-based resin has a structure derived from maleic acids, and adjacent carbon atoms have a carboxyl group or a structure derived from a carboxyl group. Here, for example, a polymer of acrylic acid is polymerized in a so-called head-tail manner when the polymer is polymerized by a commonly known method, and thus it is statistically rare for carboxyl groups to be disposed in adjacent carbon atoms. Therefore, when polymerization of a polymer of acrylic acids is compared with polymerization of maleic acids, it is rare for carboxyl groups to be disposed adjacent to each other in a carbon chain of the main chain in a polymer. In this manner, it is possible to confirm whether adjacent carboxyl groups are derived from maleic acids by a nuclear magnetic resonance (NMR) method.

The carboxyl group of the maleic acid-based resin may be esterified. For example, the carboxyl group may be esterified by a compound containing a hydroxyl group. Two carboxyl groups having a structure derived from maleic acids may not be esterified, and one or two carboxyl groups may be esterified.

Further, when the carboxyl group having a structure derived from maleic acids is not esterified, the carboxyl group may be present as a carboxylic acid in an aqueous ink jet ink composition or may be partially or completely neutralized by ammonia, alkanolamine, or alkylamine.

The maleic acid-based resin is soluble in water due to having many structures derived from the carboxyl group of maleic acids. Therefore, the molecular chain of the maleic acid-based resin expands in the aqueous ink jet ink composition. In this manner, when the ink jet ink composition is mixed with an aggregating agent, the probability that the maleic acid-based resin comes in contact with the aggregating agent increases. Accordingly, the maleic acid-based resin has satisfactory aggregating properties, and thus the image quality of an image obtained by using the ink set can be increased.

The water resistance of an image to be obtained is likely to be improved when one carboxyl group between two carboxyl groups of the structures derived from maleic acids of the maleic acid-based resin is esterified. Further, the water resistance of an image to be obtained is likely to be degraded when two carboxyl groups of the structures derived from maleic acids are not esterified. The balance between the hydrophilicity and the hydrophobicity of the maleic acid-based resin can be adjusted by the degree of esterification. In this manner, the storage stability of the ink jet ink composition can be further enhanced, and the water resistance of an image to be obtained can be further improved. For example, a styrene maleic anhydride half ester copolymer salt is preferable in terms of the balance between the hydrophilicity and the hydrophobicity. The reason for this is assumed to be that the esterified carboxyl group has high hydrophobicity, and thus insolubilization and solid-liquid separation during the reaction are promoted.

Further, when the maleic acid-based resin has structures derived from maleic anhydride, the anhydride is considered to be a carboxyl group in water due to addition of water.

Further, the maleic acid-based resin is a water-soluble resin, and a resin which is different from a pigment dispersant and is present as a solution dissolved in water serving as a solvent component of the ink without being adsorbed on a pigment in the ink jet ink composition is used as the maleic acid-based resin. The maleic acid-based resin described in this section is contained in the ink separately from a pigment dispersant when the ink contains a pigment dispersed by a pigment dispersant.

The maleic acid-based resin exhibits aggregating properties due to the action of an aggregating agent such as calcium propionate described below depending on the number and the properties of the skeletons or the functional groups of the resin constituting the particles thereof.

It is preferable that the maleic acid-based resin contain an acidic group such as a carboxyl group, a sulfonic acid group, or a phosphoric acid group. That is, the maleic acid-based resin contain an acidic group such as a carboxyl group, a sulfonic acid group, or a phosphoric acid group in the skeleton or the ester group in a state of an acid or a salt even when a carboxyl group derived from maleic acids is present in a state of an acid or a salt or all carboxyl groups derived from maleic acids are esterified. Further, the acidic group may be partially or entirely neutralized with ammonia, alkanolamine, or alkylamine.

Examples of a commercially available product of the maleic acid-based resin include SN Dispersant 5027 and 5029 (both manufactured by San Nopco Limited), SANSPARL PS-8 (manufactured by Sanyo Chemical Industries, Ltd.), MALIALIM HKM-50A, 150A, AKM-0531, SC-0505K, and POLYSTER OMA (all manufactured by NOF Corporation), DEMOL P, EP, ST, POIZ 520, and 521 (all manufactured by Kao Corporation), POLYTY A550 (manufactured by Lion Corporation), ARASTAR 703S, POLYMARON 1318, 351T, 385, 372, 375CB, 482, 482S, and 1329 (all manufactured by Arakawa Chemical Industries, Ltd.), XIRAN 1440H, 2625H, 1000H, 2000H, and 3000H (all manufactured by Polyscope), ISOBAM 104 (manufactured by Kuraray Co., Ltd.), and FLOWLEN G-700AMP and G-700DMEA (both manufactured by Kyoeisha Chemical Co., Ltd.).

The proportion of the water-soluble monomer in the molecular structure of the anionic water-soluble resin is preferably 70% by mass or less, more preferably less than 60% by mass, and still more preferably 50% by mass or less when the amount of all monomers of the water-soluble resin is set to 100% by mass. Further, the proportion of the water-soluble monomer in the molecular structure of the anionic water-soluble resin is preferably 25% by mass or greater, more preferably 30% by mass or greater, and still more preferably 40% by mass of greater when the amount of all monomers of the water-soluble resin is set to 100% by mass.

When the proportion of the water-soluble monomer in the molecular structure of the anionic water-soluble resin is less than the above-described ranges, the water solubility cannot be sufficiently obtained, and thus the water-soluble resin cannot be considered as a water-soluble polymer and stays in the form of a dispersion resin (resin particles). Meanwhile, when the proportion thereof is greater than the above-described ranges, the water-soluble resin is likely to be precipitated, and the clogging resistance may be degraded in a case where the moisture is evaporated, that is, the ink jet ink composition is in a hydrophobic state.

A water-soluble urethane-based resin denotes a water-soluble urethane resin containing a polar group in the molecular structure thereof. The polar group may be in a salt state. Further, it is preferable that the polar group be an acidic group. Examples of the acidic group include a carboxyl group, a sulfonic acid group, and a phosphorus-containing group such as a phosphoric acid group.

The water-soluble urethane-based resin has repeating units derived from a polyisocyanate and a polyol. Among such repeating units, the water-soluble urethane resin has preferably a repeating unit derived from a polyol containing an acid group and preferably repeating units each derived from a polyisocyanate, a polyol containing no acid group, and a polyol containing an acid group. The water-soluble urethane-based resin may further have a repeating unit derived from a polyamine.

A water-soluble polyester-based resin may be a resin having a polyester structure. Examples of the water-soluble resin as a nonionic water-soluble resin include polyethylene oxide, carboxymethyl cellulose, hydroxyethyl cellulose, polyvinylpyrrolidone, hydroxypropylmethyl cellulose, cellulose acetate, polyvinyl alcohol, and salts thereof.

The weight-average molecular weight Mw of the water-soluble resin is preferably 5,000 or greater and 150,000 or less, more preferably 10,000 or greater and 100,000 or less, still more preferably 15,000 or greater and 50,000 or less, even still more preferably 20,000 or greater and 30,000 or less, and even still more preferably 20,000 or greater and 23,000 or less.

When the molecular weight thereof is greater than or equal to the above-described lower limits, the viscosity of the ink jet ink composition can be more suitable, and for example, satisfactory color developability can be obtained. When the molecular weight thereof is less than or equal to the above-described upper limits, the viscosity of the ink jet ink composition can be more suitable in a case of using an ink jet method.

In the present specification, the molecular weight of the water-soluble resin is a molecular weight of a standard sample measured by a GPC method. The molecular weight may be performed with a single water-soluble resin or the ink jet ink composition containing the water-soluble resin. In this case, it is preferable that the components contained in the ink jet ink composition be specified.

The content of the water-soluble resin is preferably 0.1% by mass or greater and 10.0% by mass or less, more preferably 0.2% by mass or greater and 5.0% by mass or less, still more preferably 0.3% by mass or greater and 2% by mass or less, and even still more preferably 0.4% by mass or greater and 1.8% by mass or less. When the content of the water-soluble resin is in the above-described ranges, fixing properties of an image can be sufficiently obtained. Further, when the content thereof is in the above-described ranges, the viscosity of the ink jet ink composition is easily set to be in a more appropriate range. Further, the clogging resistance is also more excellent.

In the ink jet ink composition according to the present embodiment, the amount of the water-soluble resin and the self-dispersing pigment to be blended is set such that the mass ratio of the self-dispersing pigment to the water-soluble resin (self-dispersing pigment/water-soluble resin) is set to 2.8 or greater and less than 30. Further, such a mass ratio is preferably 3.0 or greater and 28 or less, more preferably 3.2 or greater and 25 or less, still more preferably in a range of 3.5 to 20, even still more preferably 4.0 to 10.0, even still more preferably in a range of 5.0 to 8.0, and even still more preferably in a range of 5.5 to 7.0.

The rub resistance of an image is deteriorated when the amount of the water-soluble resin is small with respect to the amount of the self-dispersing pigment, and the clogging resistance is degraded when the amount of the water-soluble resin is large with respect to the amount of the self-dispersing pigment.

### 1.3. Betaine

The betaine is a compound in which positive and negative charges are present at non-adjacent positions in the same molecule and no dissociable hydrogen is bonded to the atom having the positive charges and which can constitute intramolecular salts and does not have charges as the entire molecule. In the present embodiment, it is preferable that a positively charge moiety of the betaine be a quaternary ammonium cation.

When the ink jet ink composition contains the betaine, flight deflection and jetting failure of the ink jet ink composition caused by the ink jet ink composition being dried in a nozzle of an ink jet head can be suppressed, and the clogging resistance can be improved. Further, as described above, a state in which the above-described water-soluble resin is incorporated in (absorbed by) the betaine is considered to be formed, and as a result, it is assumed that formation of foreign matter from the water-soluble resin is suppressed and resolubility can be obtained even in a case where the water-soluble resin is formed into foreign matter. In this manner, the clogging resistance is considered to be enhanced.

The betaine is not particularly limited, and examples thereof include trialkylglycine such as trimethylglycine or triethylglycine, γ-butyrobetaine, homarine, trigonelline, carnitine, homoserine betaine, valine betaine, lysine betaine, ornithine betaine, alanine betaine, stachydrine, and glutamic acid betaine. Among these, it is preferable that the glycine contained in the ink jet ink composition be selected from trialkylglycine and more preferable that the ink jet ink composition contain trimethylglycine. The trialkylglycine is a compound in which the nitrogen atom of glycine has been substituted with three alkyl groups. In this manner, the clogging resistance is likely to be further improved. Further, the betaine may be used alone or in combination of two or more kinds thereof.

The number of carbon atoms constituting the betaine is preferably 4 or more and 12 or less, more preferably 4 or more and 7 or less, and still more preferably 4 or more and 6 or less. When the number of carbon atoms of the betaine is in the above-described ranges, the above-described effects tend to be more significant.

The content of the betaine is 2.5% by mass or greater and 9.5% by mass or less with respect to the total mass of the ink jet ink composition. Further, the content of the betaine is preferably 3% by mass or greater and 8% by mass or less and more preferably 4% by mass or greater and 8% by mass or less with respect to the total mass of the ink jet ink composition. When the content of the betaine is in the above-described ranges, formation of foreign matter from the water-soluble resin can be suppressed. When the content of the betaine is less than the above-described ranges, suppression of the water-soluble resin from being dried and solidified is likely to be insufficient, and the clogging resistance may be degraded. Further, when the content of the betaine is greater than the above-described ranges, the amount of the betaine to be dried and solidified when the betaine is dried tends to be increased, and the clogging resistance is degraded.

### 1.4. Water

The ink jet ink composition according to the present embodiment is an aqueous composition containing water. The term “aqueous” composition is a composition containing water as one of the main solvents. Examples of water include pure water such as ion exchange water, ultrafiltration water, reverse osmosis water, or distilled water, and ultrapure water which are obtained by reducing ionic impurities. Further, in a case where water sterilized by irradiation with ultraviolet rays, addition of hydrogen peroxide, or the like is used, generation of bacteria or fungi when the ink jet ink composition is stored for a long time can be suppressed.

The content of water is 30% by mass or greater, preferably 40% by mass or greater, more preferably 45% by mass or greater, and still more preferably 50% by mass or greater with respect to the total amount (100% by mass) of the ink jet ink composition. Further, the upper limit of the content of water is preferably 97% by mass or less, more preferably 90% by mass or less, still more preferably 85% by mass or less, and even still more preferably 80% by mass or less with respect to the total amount (100% by mass) of the ink composition.

### 1.5. Other Components

The ink jet ink composition according to the present embodiment may contain the following components in addition to the components described above.

### 1.5.1. Organic Solvent

The ink jet ink composition according to the present embodiment may contain an organic solvent. Examples of the organic solvent include alkyl polyol, glycol ether, and nitrogen-containing compounds. A water-soluble organic solvent is preferable as the organic solvent.

### 1.5.1.1. Alkyl Polyol

The ink jet ink composition according to the present embodiment may contain alkyl polyol. The alkyl polyol is a compound having a skeleton portion and containing two or more hydroxyl groups (substituted with two or more hydroxyl groups). Examples of the skeleton portion include an alkyl chain and a polyalkyleneoxy chain. The number of hydroxyl groups in a molecule is 2 or more, preferably 2 or more and 4 or less, and more preferably 2 or 3. The number of carbon atoms in a molecule is preferably 2 or more and 10 or less.

The concept of alkyl polyol includes polyhydric alcohol, but in a case where the ink jet ink composition contains alkyl polyol, the moisture retaining properties of the ink jet ink composition are enhanced, and the moisture evaporation from a recording head when allowed to stand for a long time can be effectively suppressed while the jetting stability using an ink jet method is improved. Further, in this manner, even when a coloring material of a type that is likely to be cause clogging of a nozzle is used, the property of recovery after standing and the continuous jetting stability can be more satisfactorily maintained.

Specific examples of the alkyl polyol include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, diethylene glycol, propylene glycol, dipropylene glycol, glycerin, triethylene glycol, and tetraethylene glycol. These alkyl polyols may be used alone or in combination of two or more kinds thereof.

Among the alkyl polyols, it is more preferable that the ink jet ink composition contain alkanediol having 3 or more and 6 or less carbon atoms. Examples of the alkanediol having 3 or more and 6 or less carbon atoms include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-1,3-propanediol, 2,2-dimethyl-1,3-propanediol, 3-methyl-1,3-butanediol, 3-methyl-1,5-pentanediol, and 2-methylpentane-2,4-diol.

When the ink jet ink composition contains the alkanediol having 3 or more and 6 or less carbon atoms, an increase in viscosity is further suppressed, and the jetting stability (continuous jetting reliability) can be more satisfactorily increased. Further, the solubility and the dispersibility of the coloring material are likely to be enhanced, and satisfactory clogging recovering properties can be obtained.

When the ink jet ink composition contains the alkyl polyol, it is more preferable that the ink jet ink composition contain polyols having a standard boiling point of higher than 280° C. Examples of the polyols having a standard boiling point of higher than 280° C. include glycerin and triethylene glycol. When the ink jet ink composition contains such polyols, an increase in drying speed of the ink jet ink composition can be suppressed, and the clogging resistance and the jetting stability can be further enhanced.

When the ink jet ink composition contains the alkyl polyol, the content thereof is preferably 2% by mass or greater and 30% by mass or less, more preferably 5% by mass or greater and 20% by mass or less, and still more preferably 8% by mass or greater and 15% by mass or less with respect to the total amount of the ink jet ink composition.

### 1.5.1.2. Glycol Ether

The ink jet ink composition according to the present embodiment may contain glycol ether. Examples of the glycol ether include monoalkyl ether and dialkyl ether of glycol selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. More specific examples thereof include methyl triglycol (triethylene glycol monomethyl ether), butyl triglycol (triethylene glycol monobutyl ether), butyl diglycol (diethylene glycol monobutyl ether), and dipropylene glycol monopropyl ether, and typical examples thereof include diethylene glycol monobutyl ether.

Among the glycol ethers, it is still more preferable that the ink jet ink composition contain one or more kinds selected from glycol ether represented by Formula (1).

R¹—O—(CH₂—CH₂₋₀)ₙ—R² (1)

(In Formula (1), R¹ represents H or an alkyl group having 1 or more and 4 or less carbon atoms, R² represents an alkyl group having 1 or more and 4 or less carbon atoms, and n represents an integer of 2 or greater and 3 or less.)

Examples of the glycol ether represented by Formula (1) include methyl triglycol (triethylene glycol monomethyl ether), butyl triglycol (triethylene glycol monobutyl ether), butyl diglycol (diethylene glycol monobutyl ether), triethylene glycol dimethyl ether, triethylene glycol dibutyl ether, and diethylene glycol dibutyl ether.

The glycol ether may be used in the form of a mixture of a plurality of kinds thereof. From the viewpoint of adjusting the viscosity of the ink jet ink composition and suppressing clogging due to the moisture retaining effect, the amount thereof to be blended is 0.5% by mass or greater and 30% by mass or less, preferably 1.0% by mass or greater and 20% by mass or less, and more preferably 3.0% by mass or greater and 10.0% by mass or less with respect to the total amount of the ink jet ink composition.

### 1.5.1.3. Nitrogen-Containing Compounds

The ink jet ink composition according to the present embodiment may contain nitrogen-containing compounds. For example, amides are preferable as the nitrogen-containing compounds. Examples of the amides include a cyclic amide and an acyclic amide. The nitrogen-containing compounds can be expected to have an effect of suppressing the ink jet ink composition from being solidified or dried.

Examples of the cyclic amide include a compound having a ring structure that contains an amide group. Examples of such a compound include γ-lactams such as 2-pyrrolidone, 1-methyl-2-pyrrolidone (N-methyl-2-pyrrolidone), 1-ethyl-2-pyrrolidone (N-ethyl-2-pyrrolidone), 1-propyl-2-pyrrolidone, 1-butyl-2-pyrrolidone, and N-vinyl-2-pyrrolidone (NVP), β-lactams, δ-lactams, and ε-lactams such as ε-caprolactam. These cyclic amides may be used alone or in combination of two or more kinds thereof.

### 1.5.1.4. Other Organic Solvents

The ink jet ink composition according to the present embodiment may contain other organic solvents. Examples of the other organic solvents include lactones such as γ-butyrolactone and a betaine compound.

The content of the organic solvent is preferably 2% by mass or greater and 30% by mass or less, more preferably 5% by mass or greater and 20% by mass or less, and still more preferably 8% by mass or greater and 15% by mass or less with respect to the total amount of the ink jet ink composition.

### 1.5.2. Resin Particles

The ink jet ink composition may contain resin particles. The resin particles will also be referred to as a dispersion resin. Since the resin particles are likely to cause degradation of the clogging resistance, the content of the resin particles when the ink jet ink composition contains the resin particles is preferably 18 by mass or less, more preferably 0.5% by mass or less, still more preferably 0.3% by mass or less, even still more preferably 0.1% by mass or less, and particularly preferably less than 0.1% by mass with respect to the total mass of the ink jet ink composition. For the same reason as described above, it is more preferable that the ink jet ink composition contain no resin particles.

When the ink contains resin particles, the ink is easily foamed and thus air bubbles are likely to be formed due to the surfactant (dispersant) for dispersing the resin. Air bubbles are likely to be formed particularly when the ink storage container is filled with the ink from the ink filling hole. Further, the resin particles are likely to be formed into foreign matter at the gas-liquid interface inside the ink storage container.

Further, when air bubbles are formed, the number of gas-liquid interfaces is increased, and thus foreign matter is likely to be formed at the gas-liquid interfaces. Further, since the resin particles are not soluble in water, there are concerns of environmental problems due to microplastics when the ink flows out to the natural environment. Examples of the resin dispersion include a dispersion resin dispersed by a surfactant and a soap-free dispersion resin dispersed without using a surfactant.

### 1.5.3. Surfactant

The ink jet ink composition according to the present embodiment may contain a surfactant. The surfactant can be used for reducing the surface tension of the ink jet ink composition to adjust and improve the wettability with respect to a recording medium and the permeability into, for example, fabrics. As the surfactant, any of nonionic surfactant, an anionic surfactant, a cationic surfactant, or an amphoteric surfactant can be used, and these surfactants may be used in combination. Further, among the surfactants, an acetylene glycol-based surfactant, a silicone-based surfactant, and a fluorine-based surfactant can be more preferably used.

The acetylene glycol-based surfactant is not particularly limited, and examples thereof include SURFYNOL 104, 104E, 104H, 104A, 104BC, 104DPM, 104PA, 104PG-50, A104S, 420, 440, 465, 485, SE, SE-F, 504, 61, DF37, CT111, CT121, CT131, CT136, TG, GA, and DF110D (all trade names, manufactured by Air Products and Chemicals Inc.), OLFINE B, Y, P, A, STG, SPC, E1004, E1010, PD-001, PD-002W, PD-003, PD-004, PD-005, EXP. 4001, EXP. 4036, EXP. 4051, EXP. 4123, EXP. 4200, EXP. 4300, D-10PG, AF-103, AF-104, AK-02, SK-14, and AE-3 (all trade names, manufactured by Nissin Chemical Co., Ltd.), and ACETYLENOL E00, E00P, E40, and E100 (all trade names, manufactured by Kawaken Fine Chemicals Co., Ltd.).

The silicone-based surfactant is not particularly limited, and preferred examples thereof include a polysiloxane-based compound. The polysiloxane-based compound is not particularly limited, and examples thereof include polyether-modified organosiloxane. Examples of a commercially available product of the polyether-modified organosiloxane include BYK-306, BYK-307, BYK-333, BYK-341, BYK-345, BYK-346, and BYK-348 (all trade names, manufactured by BYK-Chemie Japan K.K.), and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all trade names, manufactured by Shin-Etsu Chemical Co., Ltd.).

As the fluorine-based surfactant, a fluorine-modified polymer is preferably used, and examples thereof include BYK-340 (trade name, manufactured by BYK-Chemie Japan K.K.).

When the surfactant is blended into the ink jet ink composition, the content of the surfactant is 0.01% by mass or greater and 3% by mass or less, preferably 0.05% by mass or greater and 2% by mass or less, more preferably 0.1% by mass or greater and 1.5% by mass or less, and particularly preferably 0.2% by mass or greater and 1% by mass or less with respect to the total amount of the ink jet ink composition.

When the surfactant is blended into the ink jet ink composition, it is more preferable to select a surfactant having defoaming properties. In a case where the ink jet ink composition contains a surfactant having defoaming properties, the stability when the ink is jetted from a head tends to increase.

### 1.5.4. Chelating Agent

The ink jet ink composition according to the present embodiment may use a chelating agent. The chelating agent is capable of removing predetermined ions from the ink jet ink composition.

Examples of the chelating agent include ethylenediaminetetraacetic acid and salts thereof such as EDTA, ethylenediaminetetraacetic acid disodium salt dehydrate (EDTA-2Na), ethylenediaminetetraacetic acid trisodium salt monohydrate (EDTA-3Na), ethylenediaminetetraacetic acid tetrasodium salt (EDTA-4Na), and ethylenediaminetetraacetic acid tripotassium salt monohydrate (EDTA-3K), diethylenetriaminetetraacetic acid and salts thereof such as DTPA, diethylenetriaminetetraacetic acid disodium salt (DTPA-2Na) and diethylenetriaminetetraacetic acid pentasodium salt (DTPA-5Na), nitrilotriacetic acid and salts thereof such as NTA, nitrilotriacetic acid disodium salt (NTA-2Na) and nitrilotriacetic acid trisodium salt (NTA-3Na), ethylenediamine-N,N′-disuccinic acid and salts thereof, 3-hydroxy-2,2′-iminodisuccinic acid and salts thereof, L-aspartic acid-N,N′-diacetic acid and salts thereof, L-glutamic acid diacetic acid and salts thereof, N-(1-carboxylatomethyl)iminodiacetic acid and salts thereof, and N-(2-hydroxyethyl)iminodiacetic acid and salts thereof.

Further, examples of the chelating agent other than acetic acid analogues include ethylenediaminetetramethylenephosphonic acid and salts thereof, ethylenediaminetetrametaphosphoric acid and salts thereof, ethylenediaminepyrophosphoric acid and salts thereof, and ethylenediaminemetaphosphoric acid and salts thereof.

When the ink jet ink composition according to the present embodiment contains the chelating agent, one or two or more kinds selected from the above-described examples can be used.

### 1.5.5. pH Adjuster

A pH adjuster can be added to the ink jet ink composition according to the present embodiment. The pH adjuster is not particularly limited, and examples thereof include appropriate combinations of acids, bases, weak acids, and weak bases. As the acids and the bases used in such combinations, examples of inorganic acids include sulfuric acid, hydrochloric acid, and nitric acid, examples of inorganic bases include lithium hydroxide, sodium hydroxide, potassium hydroxide, potassium dihydrogen phosphate, disodium hydrogen phosphate, potassium carbonate, sodium carbonate, sodium hydrogen carbonate, sodium hydrogen carbonate, and ammonia, examples of organic bases include triethanolamine, tripropanolamine, diethanolamine, monoethanolamine, triisopropanolamine, diisopropanolamine, and trishydroxymethylaminomethane (THAM), and examples of organic acids include adipic acid, citric acid, succinic acid, lactic acid, good buffers such as N, N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), morpholinopropanesulfonic acid (MOPS), carbamoylmethyliminobisacetic acid (ADA), piperazine-1,4-bis(2-ethanesulfonic acid) (PIPES), N-(2-acetamido)-2-aminoethanesulfonic acid (ACES), cholamine chloride, N-tris(hydroxymethyl)methyl-2-aminoethanesulfonic acid (TES), acetamidoglycine, tricine, glycinamide, and bicine, a phosphate buffer solution, a citrate buffer solution, and a tris buffer solution. Further, among these, the ink jet ink composition contains a tertiary amine such as triethanolamine or triisopropanolamine, and a carboxyl group-containing organic acid such as adipic acid, citric acid, succinic acid, or lactic acid as a part or the entirety of the pH adjuster, which is preferable from the viewpoint of more stably obtaining a pH buffering effect.

### 1.5.6. Ureas

As a moisturizing agent of the ink jet ink composition, ureas may be used as a dyeing assistant that improves dyeing properties of a dye. Specific examples of the ureas include urea, ethylene urea, tetramethyl urea, thiourea, and 1,3-dimethyl-2-imidazolidinone. When the ink jet ink composition contains ureas, the content thereof can be set to 1% by mass or greater and 10% by mass or less with respect to the total mass of the ink jet ink composition.

### 1.5.7. Preservative, Fungicide, and Rust Inhibitor

The ink jet ink composition may use a preservative and a fungicide. Examples of the preservative and the fungicide include sodium benzoate, sodium pentachlorophenol, sodium 2-pyridinethiol-1-oxide, sodium sorbate, sodium dehydroacetate, 1,2-dibenzoisothiazolin-3-one (PROXEL CRL, PROXEL BDN, PROXEL GXL, PROXEL XL-2, PROXEL TN, and PROXEL LV, manufactured by Zeneca Inc.), and 4-chloro-3-methylphenol (PREVENTOL CMK and the like, manufactured by Bayer AG). Examples of the rust inhibitor include benzotriazole.

### 1.5.8. Saccharides

The ink jet ink composition may contain saccharides. Specific examples of the saccharides include glucose, mannose, fructose, ribose, xylose, arabinose, galactose, aldonic acid, glucitol (sorbitol), maltose, cellobiose, lactose, sucrose, trehalose, and maltotriose.

### 1.5.9. Other Components

The ink jet ink composition may further contain, as other components in addition to the above-described components, additives that can be typically used in an ink jet ink composition for ink jet, such as an antioxidant, an ultraviolet absorbing agent, and a dissolution assistant.

### 1.6. Production and Physical Properties

The ink jet ink composition according to the present embodiment can be obtained by mixing the above-described components in any order, filtering the mixture as necessary, and removing impurities. As a mixing method, a method of sequentially adding materials to a container provided with a stirrer such as a mechanical stirrer or a magnetic stirrer and stirring and mixing the materials is suitably used. For example, centrifugal filtration or filter filtration can be performed as necessary as a filtration method.

From the viewpoint of the reliability of an ink jet ink, the surface tension of the ink jet ink composition according to the present embodiment at 20° C. is preferably 20 mN/m or greater and 40 mN/m or less and more preferably 22 mN/m or greater and 35 mN/m or less. Further, from the same viewpoint as described above, the viscosity of the ink at 20° C. is preferably 1.5 mPa·s or greater and 10 mPa·s or less and more preferably 2 mPa·s or greater and 8 mPa·s or less. The surface tension and the viscosity of the ink may be set to be in the above-described ranges by a method of adjusting the kinds of the water-soluble resin, the organic solvent, and the surfactant described above, the amounts of these components and water to be added, and the like.

### 1.7. Effects and the Like

According to the ink jet ink composition according to the present embodiment, since the surface of the self-dispersing pigment contains a phosphorus-containing group, the color developability of an image to be obtained is excellent. Further, since the ink jet ink composition contains a water-soluble resin, the image is quickly fixed, the pigment is likely to remain on the surface of the recording medium, and thus the color developability is excellent. In addition, the fixing properties of the image can be sufficiently obtained by the water-soluble resin even when a self-dispersing pigment that tends to have insufficient fixing properties is used. Further, since the ink jet ink composition contains a betaine, drying and solidification of the water-soluble resin in a nozzle and an ink supply passage are suppressed, and thus clogging is unlikely to occur.

### 2. Recording Method

A recording method according to the present embodiment is performed by using an ink jet recording device that includes an ink jet head and includes a step of jetting an ink jet ink composition from the ink jet head to make the ink jet ink composition adhere to a recording medium. The ink jet ink composition is the ink jet ink composition described above.

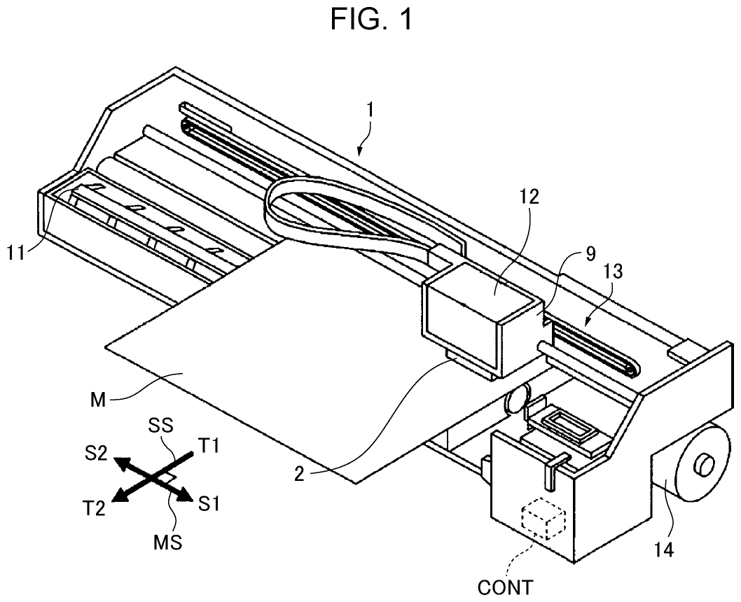

An example of the ink jet recording device that can be used for the recording method according to the present embodiment will be described with reference to the accompanying drawings. FIG. 1 is a schematic perspective view schematically showing an ink jet recording device. As shown in FIG. 1, an ink jet recording device 1 includes a recording head 2, a carriage 9, a platen 11, a carriage moving mechanism 13, a conveyance unit 14, and a control unit CONT. The operation of the entire ink jet recording device 1 is controlled by the control unit CONT shown in FIG. 1.

The recording head 2 is configured to perform recording on a recording medium M by jetting the ink from a nozzle of the recording head 2 to make the ink adhere to the recording medium M. The recording head 2 shown in FIG. 1 is a serial type recording head and performs scanning on the recording medium M a plurality of times relatively in a main scanning direction so that the ink adheres to the recording medium M. The recording head 2 is mounted on the carriage 9 shown in FIG. 1. The recording head 2 performs scanning on the recording medium M a plurality of times relatively in a main scanning direction due to an operation of the carriage moving mechanism 13 that allows the carriage 9 to move in a medium width direction of the recording medium M. The medium width direction is a main scanning direction of the recording head 2. The scanning carried out in the main scanning direction is also referred to as main scanning.

Here, the main scanning direction is a direction in which the carriage 9 on which the recording head 2 is mounted moves. In FIG. 1, the width direction of the recording medium M, that is, the direction indicated by S1-S2 is a main scanning direction MS, and the direction indicated by T1-T2 is a sub-scanning direction SS.

Further, scanning is performed once in the main scanning direction, that is, any one direction of the arrow S1 or the arrow S2. Further, an image is recorded on the recording medium M by repeatedly performing main scanning of the recording head 2 and sub-scanning which is the conveyance of the recording medium M a plurality of times.

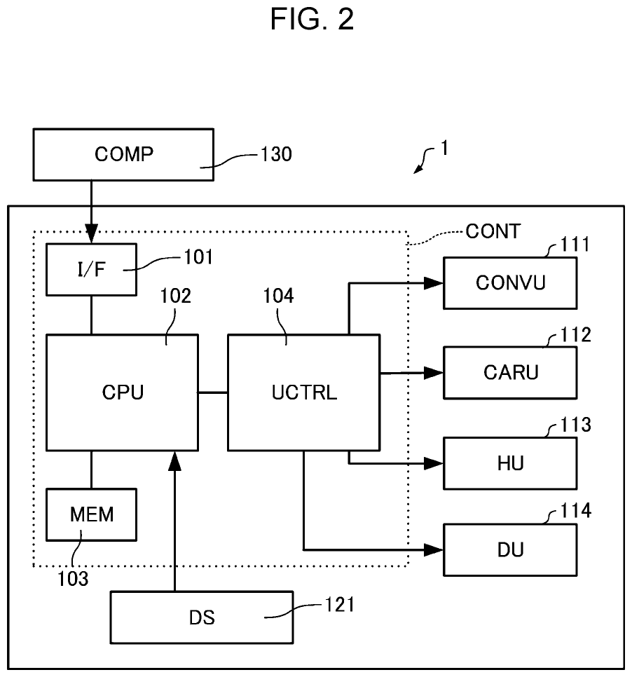

The cartridge 12 that supplies the ink to the recording head 2 includes a plurality of independent cartridges. The cartridge 12 is detachably attached to the carriage 9 on which the recording head 2 is mounted. A plurality of cartridges can be respectively filled with different kinds of inks, and the inks are supplied to respective nozzles from the cartridge 12. Further, an example in which the cartridge 12 is attached to the carriage 9 is shown in FIGS. 1 and 2, but the present disclosure is not limited thereto, and a form in which the cartridge 12 is provided at a position other than the carriage 9 and the inks are supplied to respective nozzles through supply pipes (not shown) may be employed.

The ink can be jetted from the recording head 2 using a known method of the related art. Here, a method of jetting liquid droplets using vibration of a piezoelectric element, that is, a jetting method of forming ink droplets by mechanical deformation of an electrostrictive element is used.

The platen 11 that supports the recording medium M, the carriage moving mechanism 13 that moves the carriage 9 relatively with respect to the recording medium M, and the conveyance unit 14 that is a roller conveying the recording medium M in the sub-scanning direction are provided below the carriage. The operations of the carriage moving mechanism 13 and the conveyance unit 14 are controlled by the control unit CONT.

### Electrical Control

FIG. 2 is a functional block diagram showing the ink jet recording device 1. The control unit CONT is a control unit that controls the ink jet recording device 1. An interface unit 101 (I/F) transmits and receives data between a computer 130 (COMP) and the ink jet recording device 1. A CPU 102 is an arithmetic processing unit that controls the entire ink jet recording device 1. A memory 103 (MEM) ensures an area for storing programs of the CPU 102, a working area, and the like. The CPU 102 causes a unit control circuit 104 (UCTRL) to control each unit. Further, a detector group 121 (DS) monitors the situation inside the ink jet recording device 1, and the control unit CONT controls each unit based on the detection result.

A conveyance unit 111 (CONVU) controls sub-scanning (conveyance) of ink jet recording, and specifically controls the conveyance direction and the conveyance speed of the recording medium M. More specifically, the conveyance direction and the conveyance speed of the recording medium M are controlled by controlling the rotation direction and the rotation speed of a conveyance roller driven by a motor

A carriage unit 112 (CARU) controls main scanning (pass) of ink jet recording, and specifically reciprocates the recording head 2 in the main scanning direction. The carriage unit 112 includes the carriage 9 on which the recording head 2 is mounted, and the carriage moving mechanism 13 that reciprocates the carriage 9.

A head unit 113 (HU) controls the amount of the ink to be jetted from the nozzles of the recording head 2. For example, the nozzles of the recording head 2 are driven by a piezoelectric element, the operation of the piezoelectric element in each nozzle is controlled. The head unit 113 controls the timing of adhesion of each ink, the dot size of the ink, and the like. Further, the adhesion amount of the ink for one scanning is controlled by a combination of the control of the carriage unit 112 and the control of the head unit 113.

The above-described ink jet recording device 1 alternately repeats the operation of moving the carriage 9 on which the recording head 2 is mounted in the main scanning direction and the conveyance operation (sub-scanning). Here, when each pass is performed, the control unit CONT controls the carriage unit 112, moves the recording head 2 in the main scanning direction, and controls the head unit 113 so that the liquid droplets of the ink are jetted from a predetermined nozzle hole of the recording head 2 to make the liquid droplets of the ink adhere to the recording medium M. Further, the control unit CONT controls the conveyance unit 111 so that a predetermined conveyance amount (feed amount) of the recording medium M is conveyed in the conveyance direction during the conveyance operation.

In the ink jet recording device 1, the recording area to which a plurality of liquid droplets are adhered is gradually conveyed by repeatedly performing main scanning (pass) and sub-scanning (conveyance operation). An image is completed by drying the liquid droplets adhered to the recording medium M. Thereafter, the completed recording material may be wound up into a roll shape using a winding mechanism or may be conveyed by a flat bed mechanism. Alternatively, the recording medium may be discharged to a paper discharge tray. When printing is continuously performed, the recording media may be discharged to the paper discharge tray to be laminated.

The step of making the ink jet ink composition adhere to the recording medium can be performed by using the above-described ink jet recording device. That is, the step of making the ink jet ink composition adhere to the recording medium can be performed by filling the ink jet head with the ink jet ink composition such that the ink jet ink composition can be jetted from a predetermined nozzle and jetting the ink jet ink composition to the recording medium at a predetermined timing in the above-described state.

Further, the recording method according to the present embodiment may include a step of heating the recording medium as appropriate. The step of heating the recording medium can be performed by, for example, using the above-described drying method or the like when the ink jet recording device is used. Further, the recording medium can be heated by an appropriate drying method without limiting to the ink jet recording device. In this manner, an image to be obtained can be dried, bleeding of the image can be suppressed, and the image can be more efficiently fixed.

Further, other steps can be added to the recording method according to the present embodiment as appropriate, and the recording method may include, for example, a step of applying other compositions and a washing step. According to the recording method of the present embodiment, since the above-described ink jet ink composition is used, an image with a satisfactory color developability of the ink jet ink composition and satisfactory rub resistance can be formed.

The recording method according to the present embodiment may be a recording method performed by a line type recording device in addition to the recording method performed by a serial type recording device as described in the example above.

The recording medium is not particularly limited, and the recording medium may or may not have a recording surface that adsorbs a liquid. Therefore, the recording medium is not particularly limited, and for example, paper, a film, cloth, a metal, glass, or a polymer can be used. Further, transfer paper for performing sublimation transfer to a recording medium can also be used as the recording medium. Further, the size and the length of the recording medium are not limited.

A liquid-absorbing recording medium is more preferable as the recording medium on which recording is performed by the recording method according to the present embodiment. The liquid-absorbing recording medium denotes “recording medium in which the water absorption amount from the start of contact to 30 msec^{1/2} in the Bristow method is greater than 10 mL/m²”. The Bristow method is a method that has been most widely used as a method of measuring the liquid absorption amount in a short time and that is also adopted by Japan Technical Association of The Pulp And Paper Industry (JAPAN TAPPI). The details of the recording method are described in Standard No. 51 “Paper and Paperboard, Liquid Absorbency Test Method, Bristow Method” of “Paper and Pulp Test Method (2000) by JAPAN TAPPI”.

As the liquid-absorbing recording medium, a recording medium having liquid absorbency due to a receiving layer provided to absorb a liquid on the surface of the recording medium may be used. Examples thereof include ink jet paper (paper exclusively for ink jet). Examples of the receiving layer that absorbs a liquid include a layer formed of a liquid-absorbing resin, liquid-absorbing inorganic fine particles, or the like.

Examples of the liquid-absorbing recording medium include a recording medium in which the base material of the recording medium has liquid absorbency. Examples thereof include fabrics formed of fibers and paper containing pulp as a component. Examples of the paper include plain paper, cardboard, and liner paper. Examples of the liner paper include paper formed of kraft pulp or used paper.

The step of jetting the ink jet ink composition according to the present embodiment from the ink jet head to make the ink jet ink composition adhere to the recording medium can be performed by using the ink jet recording device described above. In this manner, an image with excellent color developability can be formed. Further, the fixing properties of the image are excellent, and the clogging recovering properties of nozzles are also excellent. Further, drying and solidification of the water-soluble resin in a nozzle and an ink supply passage are suppressed. Further, since the image is quickly fixed due to the water-soluble resin, sinking of the ink components is suppressed, and an image with more satisfactory color developability is obtained when recording is performed on a liquid-absorbing recording medium.

Further, since the above-described ink jet ink composition is used in the recording method according to the present embodiment, the image is fixed rapidly due to the water-soluble resin, and the rub resistance can be quickly obtained. Therefore, the recording can be performed at a higher speed. For example, when the recording medium is A4 size paper, transfer between the stacked recording media can be suppressed even in a case where the recording speed is set to 30 sheets/min or greater, preferably 20 sheets/min or higher, and more preferably 10 sheets/min or higher. Further, when double-sided printing is performed, the ink is unlikely to adhere to the roller and the like in the conveyance passage of the recording medium after the adhesion of the ink jet ink composition.

Such effects can be obtained even when the recording medium is roll paper, and for example, offset of the ink jet ink composition can be prevented even in a case where a line printer is used or the recording medium is wound up after the recording.

According to the recording method, since the self-dispersing pigment has the surface containing a phosphorus-containing group, the color developability of an image to be obtained is excellent. Further, since the ink jet ink composition contains a water-soluble resin, the fixing properties of the image are excellent, and the clogging recovering properties of a nozzle are also excellent. Further, the fixing properties of the image can be sufficiently obtained due to the water-soluble resin even when a self-dispersing pigment that tends to have insufficient fixing properties is used. Further, since the ink jet ink composition contains a betaine, drying and solidification of the water-soluble resin in a nozzle and an ink supply passage are suppressed. These effects are exhibited by the interaction of the specific formulation of the self-dispersing pigment containing a phosphorus-containing group, the water-soluble resin, and the betaine.

### 3. Examples and Comparative Examples

Hereinafter, the present disclosure will be described in detail based on examples, but the present disclosure is not limited to these examples. Hereinafter, “parts” and “%” are on a mass basis unless otherwise specified. Further, the evaluation was performed under conditions of a temperature of 25.0° C. and a relative humidity of 40.0% unless otherwise specified.

### 4.1. Preparation of Ink Jet Ink Composition

Ink jet ink compositions of the examples and the comparative examples were obtained by adding respective components to a container to have the compositions listed in Tables 1 to 3, mixing and stirring the mixtures with a magnetic stirrer for 2 hours, and filtering the mixtures with a membrane filter having a pore size of 5 μm.

The materials listed in Tables 1 to 3 are as follows.
A phosphorus-containing group-treated self-dispersing pigment was produced in the following manner.

20.0 g of a pigment, 11.0 mmol of monosodium salt of ((4-aminobenzoylamino)-methane-1,1-diyl)bisphosphate, 20.0 mmol of nitric acid, and 200 mL of pure water were mixed with each other.

Carbon black (trade name “BLACK PEARLS 880”, manufactured by Cabot Corporation) was used as the pigment. Further, the mixture was mixed at 6,000 rpm using a Silverson mixer at room temperature. After 30 minutes, 20.0 mmol of sodium nitrite dissolved in a small amount of water was slowly added to this mixture.

The temperature of the mixture reached 60° C. by adding sodium nitrite. The mixture was allowed to react in this state for 1 hour. Thereafter, the mixture was washed with water, and the pH of the mixture was adjusted to 10 by using a sodium hydroxide aqueous solution.

The obtained pigment was a self-dispersing pigment in which a —C₆H₄—CONH—CH—(PO(OH)(ONa))(PO(OH)₂) group was bonded to the surfaces of particles of the pigment.
Non-phosphorus-containing group-treated self-dispersing pigment: CAB-O-JET (registered trademark) 300 (manufactured by Cabot Specialty Chemicals Inc.)
A dispersion resin (resin particles) was produced as resin particles in the following manner.

A reaction container provided with a stirrer, a reflux condenser, a dropping device, and a thermometer was charged with 900 g of ion exchange water and 1 g of sodium lauryl sulfate, and the temperature of the solution was heated to 70° C. while the reaction container was subjected to nitrogen substitution and the solution was stirred. The internal temperature was maintained at 70° C., 4 g of potassium persulfate was added to the solution as a polymerization initiator, and after the dissolution of the potassium persulfate, an emulsion prepared by adding 20 g of acrylamide, 365 g of styrene, 545 g of butyl acrylate, and 30 g of methacrylic acid to 450 g of ion exchange water and 3 g of sodium lauryl sulfate in advance while the solution was stirred was continuously added dropwise to the reaction container over 4 hours. After completion of the dropwise addition, the solution was aged for 3 hours. The obtained resin emulsion was cooled to room temperature, and ion exchange water and a sodium hydroxide aqueous solution were added to the emulsion to adjust the solid content to 40% by mass and the pH to 8. The glass transition temperature of the resin particles in the obtained aqueous emulsion was −6° C.
A water-soluble polymer 1 was produced in the following manner.

93.4 parts of butanol was added to a reaction container provided with a gas introduction pipe, a thermometer, a condenser, and a stirrer, and the reaction container was subjected to nitrogen gas substitution. The reaction container was heated to 110° C., and a mixture of 101.1 parts of styrene, 38.5 parts of acrylic acid, 60.0 parts of maleic acid, and 6 parts of a polymerization initiator (trade name “V-601”, manufactured by FUJIFILM Wako Pure Chemical Corporation) was added dropwise to the reaction container over 2 hours to cause a polymerization reaction. The mixture was allowed to react at 110° C. for 3 hours, 0.6 parts of a polymerization initiator was further added thereto, and the mixture was allowed to continuously react at 110° C. for 1 hour, thereby obtaining a solution of a resin. The mixture was cooled to room temperature, 37.1 parts of dimethylaminoethanol was added thereto to neutralize the mixture, and 100 parts of water was further added thereto. The mixture was heated to 100° C. or higher, an azeotrope was formed with water to distill off butanol, and the concentration thereof was adjusted. In this manner, a liquid containing a water-soluble resin 1 in which the content of the resin was 20.0% was obtained. The acid value of the water-soluble resin 1 was 440 mgKOH/g measured by a titration method, the proportion of the water-soluble monomer was 49% by mass, and the weight-average molecular weight was 12,000.
A water-soluble polymer 2 was produced in the following manner.

93.4 parts of butanol was added to a reaction container provided with a gas introduction pipe, a thermometer, a condenser, and a stirrer, and the reaction container was subjected to nitrogen gas substitution. The reaction container was heated to 110° C., and a mixture of 101.5 parts of styrene, 98.5 parts of acrylic acid, and 6 parts of a polymerization initiator (trade name “V-601”, manufactured by FUJIFILM Wako Pure Chemical Corporation) was added dropwise to the reaction container over 2 hours to cause a polymerization reaction. The mixture was allowed to react at 110° C. for 3 hours, 0.6 parts of a polymerization initiator was further added thereto, and the mixture was allowed to continuously react at 110° C. for 1 hour, thereby obtaining a solution of a resin. The mixture was cooled to room temperature, 37.1 parts of dimethylaminoethanol was added thereto to neutralize the mixture, and 100 parts of water was further added thereto. The mixture was heated to 100° C. or higher, an azeotrope was formed with water to distill off butanol, and the concentration thereof was adjusted. In this manner, a liquid containing a water-soluble resin 2 in which the content of the water-soluble resin 2 was 20.0% was obtained. The acid value of the water-soluble resin 2 was 383 mgKOH/g measured by a titration method, the proportion of the water-soluble monomer was 49% by mass, and the weight-average molecular weight was 12,000.
A water-soluble polymer 3 (60% or greater of a water-soluble monomer) was produced in the following manner.

93.4 parts of butanol was added to a reaction container provided with a gas introduction pipe, a thermometer, a condenser, and a stirrer, and the reaction container was subjected to nitrogen gas substitution. The reaction container was heated to 110° C., and a mixture of 101.5 parts of styrene, 38.5 parts of acrylic acid, 210.0 parts of maleic acid, and 6 parts of a polymerization initiator (trade name “V-601”, manufactured by FUJIFILM Wako Pure Chemical Corporation) was added dropwise to the reaction container over 2 hours to cause a polymerization reaction. The mixture was allowed to react at 110° C. for 3 hours, 0.6 parts of a polymerization initiator was further added thereto, and the mixture was allowed to continuously react at 110° C. for 1 hour, thereby obtaining a solution of a resin. The mixture was cooled to room temperature, 37.1 parts of dimethylaminoethanol was added thereto to neutralize the mixture, and 100 parts of water was further added thereto. The mixture was heated to 100° C. or higher, an azeotrope was formed with water to distill off butanol, and the concentration thereof was adjusted. In this manner, a liquid containing a water-soluble resin 3 in which the content of the water-soluble resin 3 was 20.0% was obtained. The acid value of the water-soluble resin 3 was 664 mgKOH/g measured by a titration method, the proportion of the water-soluble monomer was 71% by mass, and the weight-average molecular weight was 12,000.
A water-soluble polymer 4 (less than 60% of a water-soluble monomer) was produced in the following manner.

93.4 parts of butanol was added to a reaction container provided with a gas introduction pipe, a thermometer, a condenser, and a stirrer, and the reaction container was subjected to nitrogen gas substitution. The reaction container was heated to 110° C., and a mixture of 150.0 parts of styrene, 25.0 parts of acrylic acid, 30.0 parts of maleic acid, and 6 parts of a polymerization initiator (trade name “V-601”, manufactured by FUJIFILM Wako Pure Chemical Corporation) was added dropwise to the reaction container over 2 hours to cause a polymerization reaction. The mixture was allowed to react at 110° C. for 3 hours, 0.6 parts of a polymerization initiator was further added thereto, and the mixture was allowed to continuously react at 110° C. for 1 hour, thereby obtaining a solution of a resin. The mixture was cooled to room temperature, 37.1 parts of dimethylaminoethanol was added thereto to neutralize the mixture, and 100 parts of water was further added thereto. The mixture was heated to 100° C. or higher, an azeotrope was formed with water to distill off butanol, and the concentration thereof was adjusted. In this manner, a liquid containing a water-soluble resin 4 in which the content of the water-soluble resin 4 was 20.0% was obtained. The acid value of the water-soluble resin 4 was 236 mgKOH/g measured by a titration method, the proportion of the water-soluble monomer was 27% by mass, and the weight-average molecular weight was 12,000.
OLFINE E1010: manufactured by Nissin Chemical Co., Ltd., acetylene glycol-based surfactant
OLFINE EXP4300: manufactured by Nissin Chemical Co., Ltd., acetylene glycol-based surfactant
OLFINE D-10PG: manufactured by Nissin Chemical Co., Ltd., acetylene glycol-based surfactant

### 4.2. Evaluation Method

### 4.2.1. Recording Test

A modified machine of PX-S840 (cartridge type) (manufactured by Seiko Epson Corporation) was prepared. XeroxP (manufactured by Fuji Xerox Co., Ltd.) was used as a recording medium used for performing recording of a recording test. A monochrome 100% Duty pattern 101 was recorded by setting the adhesion amount of the ink to the recording medium to 4 mg/inch².

4.2.2. LM Property Immediately after Printing (Line Marker Test Immediately after Recording)

An image immediately after being recorded was rubbed with a line marker once or twice, and the visually observed results were evaluated according to the following evaluation criteria. The evaluation results are listed in Tables 4 to 6. Since the test was performed on the image immediately after printing, the rank of B or higher is desirable and the rank of A or higher is more desirable.
A: The mark was not noticeable even when the image was rubbed twice.
B: The mark was not noticeable when the image was rubbed once.
C: The mark was noticeable when the image was rubbed once.
   4.2.3. LM Property after 5 Minutes from Printing (Line Marker Test 5 Minutes after Recording)

An image allowed to remain for 5 minutes after being recorded was rubbed with a line marker once or twice, and the visually observed results were evaluated according to the following evaluation criteria. The evaluation results are listed in Tables 4 to 6. Since the test was performed on the image allowed to remain for 5 minutes after being printed, the rank of A or higher is desirable.
A: The mark was not noticeable even when the image was rubbed twice.
B: The mark was not noticeable when the image was rubbed once.
C: The mark was noticeable when the image was rubbed once.

### 4.2.4. Clogging Resistance

The cartridges of recording devices were respectively filled with the ink of each example, the recording test was performed, and the cartridges were allowed to stand in an environment of 40° and 20% RH for 7 days in a state where the heads were not covered with a cap, and the heads were cleaned. The clogging recovering properties were determined according to the following evaluation criteria based on the number of times of cleaning, and the results are listed in Tables 4 to 6.
A: Clogging was recovered within 6 times of cleaning.
B: Clogging was recovered within 7 times or 8 times of cleaning.
C: Clogging was not recovered after 8 times of cleaning.

### 4.2.5. Optical Density (OD Value)

The monochrome 100% Duty pattern 101 was measured by a colorimeter. The evaluation was performed according to the following evaluation criteria based on the obtained OD values. The evaluation results are listed in Tables 4 to 6. The rank of B or higher is desirable.
A: The OD value was 1.1 or greater.
B: The OD value was 0.9 or greater and less than 1.1.
C: The OD value was less than 0.9.

### 4.2.6. Evaluation of Transferability

Recording was performed on A4 size plain paper XP using the above-described recording device at the recording speed listed in Tables 4 to 6. A single side of the plain paper was used for printing, and the printing pattern was a solid pattern with a size of 10 cm×10 cm (ink adhesion amount of 7 mg/inch²). 100 sheets of the plain paper were stacked on the discharge tray. The evaluation was performed after the printing according to the following evaluation criteria.
A: The ink was not transferred to the rear surface.
B: A slight amount of ink was transferred to the rear surface.
C: A significant amount of ink was transferred to the rear surface.

### 4.2.7. Evaluation of Countermeasure for Microplastics

It was determined whether the ink contained water-insoluble resins. The results are listed in Tables 1 to 3. The rank of A is desirable.
A: The ink contained no water-insoluble resins.
B: The ink contained water-insoluble resins.

### 4.3. Evaluation Results

As listed in Tables 4 to 6, it was found that the ink jet ink composition of each example, containing a self-dispersing pigment obtained by introducing a phosphorus-containing group to the pigment, a water-soluble resin, and a betaine, in which the acid value of the water-soluble resin was 250 mgKOH/g or greater and 600 mgKOH/g or less, the content of the self-dispersing pigment was 3.5% by mass or greater and 8.5% by mass or less with respect to a total mass of the ink composition, the mass ratio (self-dispersing pigment/water-soluble resin) of the self-dispersing pigment to the water-soluble resin was 2.8 or greater and less than 30, and the content of the betaine was 2.5% by mass or greater and 9.5% by mass or less with respect to the total mass of the ink composition, had satisfactory clogging resistance, rub resistance, and color developability.

The present disclosure has configurations that are substantially the same as the configurations described in the embodiments, for example, configurations with the same functions, the same methods, and the same results as described above or configurations with the same purposes and the same effects as described above. Further, the present disclosure has configurations in which parts that are not essential in the configurations described in the embodiments have been substituted. Further, the present disclosure has configurations exhibiting the same effects as the effects of the configurations described in the embodiments or configurations capable of achieving the same purposes as the purposes of the configurations described in the embodiments. Further, the present disclosure has configurations in which known techniques have been added to the configurations described in the embodiments.

The following contents are derived from the embodiments and the modified examples described above.

An ink jet ink composition is an ink jet ink composition including a self-dispersing pigment, a water-soluble resin, and a betaine, in which the self-dispersing resin is a self-dispersing resin obtained by introducing a phosphorus-containing group to the pigment, the water-soluble resin has an acid value of 250 mgKOH/g or greater and 600 mgKOH/g or less, a content of the self-dispersing pigment is 3.5% by mass or greater and 8.5% by mass or less with respect to a total mass of the ink composition, a mass ratio (self-dispersing pigment/water-soluble resin) of the self-dispersing pigment to the water-soluble resin is 2.8 or greater and less than 30, and a content of the betaine is 2.5% by mass or greater and 9.5% by mass or less with respect to the total mass of the ink composition.

According to the recording method, since the self-dispersing pigment has the surface containing a phosphorus-containing group, the color developability of an image to be obtained is excellent. Further, since the ink jet ink composition contains a water-soluble resin, the image is quickly fixed, the pigment is likely to remain on the surface of the recording medium, and thus the color developability is excellent. Further, the fixing properties of the image can be sufficiently obtained due to the water-soluble resin even when a self-dispersing pigment that tends to have insufficient fixing properties is used. Further, since the ink jet ink composition contains a betaine, drying and solidification of the water-soluble resin in a nozzle and an ink supply passage are suppressed, and thus clogging is unlikely to occur.

In the ink jet ink composition described above, the phosphorus-containing group may be a phosphonic acid group.

According to the ink jet ink composition, the fixing properties of the image are further enhanced.

In the ink jet ink composition described above, a content of the water-soluble resin may be 0.3% by mass or greater and 2% by mass or less with respect to the total mass of the ink composition.

According to the ink jet ink composition, the fixing properties of the image are more appropriate, and the viscosity is further enhanced.

In the ink jet ink composition described above, a content of a resin particle may be less than 0.1% by mass with respect to the total mass of the ink composition.

According to the ink jet ink composition, generation of foreign matter is further suppressed.

In the ink jet ink composition described above, the water-soluble resin may be selected from an acrylic resin or a maleic acid-based resin.

According to the ink jet ink composition, the image quality of the image to be obtained can be further enhanced.

In the ink jet ink composition described above, a proportion of a water-soluble monomer in the water-soluble resin may be 30% by mass or greater and 60% by mass or less when an amount of all monomers in the water-soluble resin is set to 100% by mass.

According to the ink jet ink composition, clogging can be further reduced, and the water solubility can be more sufficiently obtained.

In the ink jet ink composition described above, the betaine may be selected from trialkylglycine.

According to the ink jet ink composition, aggregation of the water-soluble resin is unlikely to occur.

In the ink jet ink composition described above, the ink composition may be used for performing recording on an absorbing recording medium.

According to the ink jet ink composition, an image with more satisfactory color developability can be obtained even when an absorbing recording medium is used.

In the ink jet ink composition described above, the ink jet ink composition may further contain polyols having a standard boiling point of higher than 280° C.

According to the ink jet ink composition, clogging is more likely to be suppressed.

A recording method performed by using an ink jet recording device that includes an ink jet head, the method including a step of jetting an ink jet ink composition from the ink jet head to make the ink jet ink composition adhere to a recording medium, in which the ink jet ink composition is the ink jet ink composition described above.

According to the recording method, since the self-dispersing pigment has the surface containing a phosphorus-containing group, the color developability of an image to be obtained is excellent. Further, since the ink jet ink composition contains a water-soluble resin, the fixing properties of the image are excellent, the image is quickly fixed, and thus the color developability is excellent and the recording can be performed at a higher speed. Further, the fixing properties of the image can be sufficiently obtained due to the water-soluble resin even when a self-dispersing pigment that tends to have insufficient fixing properties is used. Further, since the ink jet ink composition contains a betaine, drying and solidification of the water-soluble resin in a nozzle and an ink supply passage are suppressed. These effects are exhibited by the interaction of the specific formulation of the self-dispersing pigment containing a phosphorus-containing group, the water-soluble resin, and the betaine.

In the recording method described above, a recording speed may be 20 sheets/min or greater.

According to the recording method, the image is quickly fixed, and thus the recording can be performed at a higher speed.

What is claimed is:

1. An aqueous ink jet ink composition comprising:
a self-dispersing pigment;
a water-soluble resin; and
a betaine,
wherein the self-dispersing resin is a self-dispersing resin obtained by introducing a phosphorus-containing group to the pigment,
the water-soluble resin has an acid value of 250 mgKOH/g or greater and 600 mgKOH/g or less,
a content of the self-dispersing pigment is 3.5% by mass or greater and 8.5% by mass or less with respect to a total mass of the ink composition,
a mass ratio (self-dispersing pigment/water-soluble resin) of the self-dispersing pigment to the water-soluble resin is 2.8 or greater and less than 30, and
a content of the betaine is 2.58 by mass or greater and 9.5% by mass or less with respect to the total mass of the ink composition.

2. The ink jet ink composition according to claim 1,
wherein the phosphorus-containing group is a phosphonic acid group.

3. The ink jet ink composition according to claim 1,
wherein a content of the water-soluble resin is 0.3% by mass or greater and 2% by mass or less with respect to the total mass of the ink composition.

4. The ink jet ink composition according to claim 1,
wherein a content of a resin particle is less than 0.1% by mass with respect to the total mass of the ink composition.

5. The ink jet ink composition according to claim 1,
wherein the water-soluble resin is selected from an acrylic resin or a maleic acid-based resin.

6. The ink jet ink composition according to claim 1,
wherein a proportion of a water-soluble monomer in the water-soluble resin is 30% by mass or greater and 60% by mass or less when an amount of all monomers in the water-soluble resin is set to 100% by mass.

7. The ink jet ink composition according to claim 1,
wherein the betaine is selected from trialkylglycine.

8. The ink jet ink composition according to claim 1,
wherein the ink composition is used for performing recording on an absorbing recording medium.

9. The ink jet ink composition according to claim 1, further comprising:
polyols having a standard boiling point of higher than 280° C.

10. A recording method performed by using an ink jet recording device that includes an ink jet head, the method comprising:
jetting an ink jet ink composition from the ink jet head to make the ink jet ink composition adhere to a recording medium,
wherein the ink jet ink composition is the ink jet ink composition according to claim 1.

11. The recording method according to claim 10,
wherein a recording speed is 20 sheets/min or greater.
